(19) United States
(12) Patent Application Publication
(10) Pub. No.: US 2006/0265300 A1
(43) Pub. Date: Nov. 23, 2006

(54) Financial contracts and market indicators based on such financial contracts

(75) Inventor: Jan Vecer, New York, NY (US)

Correspondence Address: WILMER CUTLER PICKERING HALE AND DORR LLP;COLUMBIA UNIVERSITY, 399 PARK AVENUE, NEW YORK, NY, 10020, US

(73) Assignee: THE TRUSTEES OF COLUMBIA UNIVERSITY, New York, NY (US)

(21) Appl. No.: 11/339,936

(22) Filed: Jan. 25, 2006

Related U.S. Application Data
(60) Provisional application No. 60/674,237, filed on Apr. 22, 2005.
(60) Provisional application No. 60/686,782, filed on Jun. 2, 2005.

(51) Int. Cl. G06Q 40/00

(52) U.S. Cl. 705/35

(57) ABSTRACT

Products and methods for providing investors with one or more financial contracts, based on average drawdown, average drawup, and/or average range are provided. Some embodiments of the present invention allow investors to insure their underlying assets from unexpected market movements such as a market crash, market rally, and/or range event using one or more of average drawdown, average drawup, and/or average range values.

### CROSS-REFERENCE TO RELATED APPLICATIONS

The present application claims the benefit of U.S. Provisional Application No. 60/686,782, filed Jun. 2, 2005, and 60/674,237, filed Apr. 22, 2005, the contents of which are hereby incorporated by reference herein in their entireties.

### BACKGROUND OF THE INVENTION

1. Field of the Invention

The present application generally relates to new types of financial contracts such as forward or futures contracts and option contracts. More particularly, the present invention relates to financial contracts such as crash options, rally options, and range options, and financial contracts based on various drawdowns, drawups, and/or ranges.

2. Description of Related Art

Financial contracts are contracts between two contracting parties regarding an exchange of cash flow along a certain timeline. Examples of such financial contracts include forwards or futures, options, and the like.

Forward or futures contracts include cash market transactions where the price of a certain item to be delivered is determined on the initial trade date, but the delivery of the item is deferred until after the contract has been made.

Options are financial contracts that insure against some specific movements of an underlying asset (e.g., a stock price, interest rate, exchange rate, commodity price, etc.). As an insurance contract, they have a positive price, and determination of this price is a question of the option pricing theory. The option pricing theory also answers the question of how to hedge such contracts by trading in the underlying asset.

Several types of options currently exist and are distinguished based on their payoffs. Two traditional options are call options and put options. In a call option, the payoff can be represented by
(S_{T}−K)⁺, [1]
wherein T represents the time of maturity of the asset, K represents the strike price (which is contractually agreed upon), and S_{T} represents the price of the asset at the time of maturity. As shown above, the holder of the option receives the difference between the asset price (S_{T}) and the strike price (K), provided this difference is positive. However, the option expires as worthless if the strike price (K) is above the asset price at the time of maturity (S_{T}). The call option therefore insures against the event of a market rise.

A put option is another example of a currently traded option. In this option, the payoff can be represented by
(K−S_{T})⁺, [2]
wherein the variables are as previously defined. In a put option, the holder receives the difference between the strike price (K) and the asset price at the time of maturity (S_{T}), provided this difference is positive. However, the option expires as worthless if the strike price (K) is below the asset price (S_{T}) at the time of maturity. The put option therefore insures against the event of a market fall.

In addition to the two above-mentioned traditional options, less common options (often referred to as “exotics”) are also currently traded. Examples of such exotic options include barrier options, lookback options, and Asian options.

Barrier options depend upon the behavior of the maximum of the asset price, the minimum of the asset price, and/or the type of the option (call or put). One example of a barrier option is the up and out barrier call option. For this option, the payoff can be represented by

$${( {S}_{T} - K )}^{+} if {M}_{T} {△}_{=} {max}_{0 \leq t \leq T} {S}_{t} \leq B , \qquad [ 3 ]$$

wherein M_{T} is the maximum of the asset price up to the time of maturity of the option, B is the barrier level, and the other variables are as previously defined. Here, if the maximum of the asset price (M_{T}) has not exceeded the barrier level (B) during the lifetime of the option, the payoff of the barrier option is simply the typical call option payoff. However, if the maximum of the asset price (M_{T}) has exceeded the barrier level (B) during the lifetime of the option, the option expires as worthless.

A lookback option allows the investor to “look back” at the underlying asset prices occurring over the lifetime of the option. For example, a lookback option can pay off the maximum of the asset price up to the time of the maturity of the option, and the payoff can simply be represented by the maximum of the asset price (M_{T}). While lookback options can be appealing to investors, they can be expensive and often quite speculative.

An Asian option payoff can be represented by
(\overline{S}ₜ−K)⁺, [4]
wherein \overline{S}_{T} is the average asset price calculated from the initial time of purchasing the option up to the time of the maturity of the option (i.e., the time interval [0,T]). In this option, the holder of the option receives the difference between the average asset price (\overline{S}_{T}) and the strike price (K), provided this difference is positive. The option expires as worthless if the strike price (K) is above the average asset price (\overline{S}_{T}) at the time of maturity.

Two other types of call and put options that are currently traded have payoffs that depend upon the actions of the holder of the contract. The holder of an American option can choose any single time to collect the payoff of the option up to the time of the expiration of the contract. Once this happens, the holder has exercised the option and the contract is closed. For a European option, in contrast, payoff can only be exercised by the holder at the time of maturity of the option (T), which, in this case, is the expiration of the contract.

As evidenced above, varieties of options are currently being traded in the marketplace. However, despite the fact that the aforementioned options are contracts intended to insure against adverse market movements, none adequately insures an investor against events such as a market crash, a market rally, or a steep difference in the highest and lowest price of an underlying asset, defined herein as a “range event.”

For example, all of the options described above, except for the American option, have a fixed maturity date, and therefore fail to consider a market crash, a market rally, or a range event. Furthermore, although the American option is more flexible in terms of when the option can be exercised, the American option also cannot adequately insure the asset holder in the event of an unexpected market crash, market rally, or a range event. Therefore, improved methods of insuring asset holders against various unexpected market changes are needed.

Moreover, various financial institutions are seeking out advanced financial contracts that can be sold to existing and/or potential clients. Therefore, advancements in selling financial contracts such as forward or futures contracts, call options, and put options would be desirable.

### SUMMARY OF THE INVENTION

Methods for providing an investor with new financial contracts are provided. These new financial contracts can provide insurance in the form of various options such as, for example, a crash option, a rally option, and a range option against a market crash event, a market rally event, or a range event, respectively. Moreover, new financial contracts, such as forward or futures contracts and option contracts, are provided.

In some embodiments of the present invention, a method for providing an investor with a financial contract based on an average drawdown is provided. The method includes: 1) defining an average drawdown; 2) defining a financial contract based on the average drawdown, which pays off a certain payoff amount if certain conditions specified in the financial contract are satisfied; 3) pricing the financial contract; 4) selling the financial contract to an investor; and 5) paying off the predetermined payoff amount to the investor if the certain conditions specified in the financial contract are satisfied.

In some embodiments of the present invention, a method for providing an investor with a financial contract based on an average drawup is provided. The method includes: 1) defining an average drawup; 2) defining a financial contract based on the average drawup, which pays off a certain payoff amount if certain conditions specified in the contract are satisfied; 3) pricing the financial contract; 4) selling the financial contract to an investor; and 5) paying off the predetermined payoff amount to the investor if the certain conditions specified in the financial contract are satisfied.

In some embodiments of the present invention, a method for providing an investor with a financial contract based on an average range is provided. The method includes: 1) defining an average range; 2) defining a financial contract based on the average range, which pays off a certain payoff amount if certain conditions are satisfied; 3) pricing the financial contract; 4) selling the financial contract to an investor; and 5) paying off the predetermined payoff amount to the investor if the certain conditions specified in the financial contract are satisfied.

In some embodiments of the present invention, a method for providing an investor with one or more trading accounts based on an average drawdown value is provided. The method includes: (1) defining an average drawdown value; (2) defining a financial contract based on the average drawdown value that pays off a payoff amount to the investor if one or more conditions specified in the financial contract are met during a lifetime of the financial contract; (3) pricing the financial contract; (4) determining a hedge of the financial contract using the price of the financial contract; (5) defining a payoff of the trading account using the payoff amount of the financial contract; (6) selling the trading account to the investor; and (7) paying off the payoff amount of the trading account to the investor at the end of the lifetime of the trading account.

In some embodiments of the present invention, a method for providing an investor with one or more trading accounts based on an average drawup value is provided. The method includes: (1) defining an average drawup value; (2) defining a financial contract based on the average drawup value that pays off a payoff amount to the investor if one or more conditions specified in the financial contract are met during a lifetime of the financial contract; (3) pricing the financial contract; (4) determining a hedge of the financial contract using the price of the financial contract; (5) defining a payoff of the trading account using the payoff amount of the financial contract; (6) selling the trading account to the investor; and (7) paying off the payoff amount of the trading account to the investor at the end of the lifetime of the trading account.

In some embodiments of the present invention, a method for providing an investor with one or more trading accounts based on an average range value is provided. The method includes: (1) defining an average range value; (2) defining a financial contract based on the average range value that pays off a payoff amount to the investor if one or more conditions specified in the financial contract are met during a lifetime of the financial contract; (3) pricing the financial contract; (4) determining a hedge of the financial contract using the price of the financial contract; (5) defining a payoff of the trading account using the payoff amount of the financial contract; (6) selling the trading account to the investor; and (7) paying off the payoff amount of the trading account to the investor at the end of the lifetime of the trading account.

In some embodiments of the present invention, products for providing an investor with the ability to purchase one or more desired financial contracts and/or trading accounts are provided. The products can include a system of computers and related software, the computers communicating with each other via the internet.

The attendant features and advantages of the present inventions, as well as the structure and operation of various embodiments of the present invention, are described in greater detail below with reference to the accompanying figure.

### BRIEF DESCRIPTION OF THE FIGURES

For a fuller understanding of the nature and objects of the present invention, reference should be made to the following detailed description taken in connection with the accompanying drawing, wherein:

FIG. 1 is a block schematic diagram illustrating a typical product and operation of the present invention.

### DETAILED DESCRIPTION

Crash Options

In some embodiments of the present invention, a method for providing an investor with a crash option in the event of a market crash is provided. The method includes: 1) defining a market crash event; 2) defining a crash option contract which pays off a certain payoff amount if the market crash event occurs; 3) pricing the crash option; 4) selling the crash option to an investor; and 5) paying off the predetermined payoff amount to the investor if the market crash event occurs or not paying off the predetermined payoff amount (i.e., the crash option expires as worthless) if the market crash event does not occur during the lifetime of the contract.

The crash option allows an option holder to obtain the historical maximum of an asset price within the lifetime of the contract in the event of a market crash. However, if a market crash does not occur, either before or when the contract matures, the option expires as worthless. It is to be noted that since a market crash is a rather extreme event, the likelihood of a market crash occurring before or at maturity of the option is low. Therefore, the probability of a payoff is also low. This feature can, for example, make the price of a crash option inexpensive.

Certain embodiments of the crash option may define the market crash event in terms of an absolute value. This type of a crash option will hereinafter be called an “absolute value crash option.” An absolute value market crash can be defined as the first time an asset Sₜ drops by a constant a from its running maximum (where t is time). This is represented by
Tₐ=min{t≧0:Mₜ−Sₜ≧a}, [5]
wherein

$${M}_{t} = {max}_{s \leq t} {S}_{s} .$$

Asset Sₜ may be any asset, such as a stock price, an interest rate, an exchange rate, or the like. It should be noted that different forms of Mₜ may be defined. For example,

$${M}_{t} = {max}_{t - δ \leq s \leq t} {S}_{s} ,$$

which may look at maximum asset value within a given time interval rather than the maximum asset value obtained during the lifetime of the contract. Moreover, it may also be possible to consider taking the maximum asset value from discretely sampled asset values rather than from continuous asset value feeds.

In this case, the absolute value crash option can be defined as a contract which pays off an amount a at the time of a market crash Tₐ, provided the market crash occurs before the maturity of the contract (T).

Other payoffs may include M_{T}_{ₐ}−S_{T}_{ₐ} (if the price drop does not occur in a continuous manner and thus may not equal a) or a running average of the price up to time Tₐ. These examples are not meant to be limiting, as other possible payoff amounts will readily be apparent to one of ordinary skill in the art.

Furthermore, the price of the absolute value crash option can be determined by defining the value of the absolute value crash option at time t, under the condition that the option is still alive (i.e., the market crash has not happened by time t) as shown below:
v(t,x,y)=aE[e^{-(T}^{ₐ}^{-t)}I(Tₐ<T)|Sₜ=x,Mₜ=y]. [6]
Then v(0,S₀,S₀) is the initial value of this option, and a Monte Carlo simulation can be performed to obtain the expected price. If we assume that the dynamics of the underlying asset price is a standard geometric Brownian motion, i.e.,
dSₜ=rSₜdt+σSₜdWₜ [7]
we can get a partial differential equation representing the value of this contract. Similar to the lookback options descried in page 309 of Shreve (Shreve, S., “Stochastic Calculus for Finance II,” Springer-Verlag, 2004), which is incorporated by reference herein in its entirety, we obtain

$${v}_{t} ( t , x , y ) + r x {v}_{x} ( t , x , y ) + \frac{1}{2} {σ}^{2} {x}^{2} {v}_{xx} ( t , x , y ) = r v ( t , x , y ) \qquad [ 8 ]$$

in the region {(t,x,y); 0≦t<T,x≦y≦x+a}. The equation satisfies the boundary condition
v(t,0,y)=0, 0≦t≦T,y<a,
v(t,y−a,y)=a, 0≦t≦T,y≧a,
v_{y}(t,y,y)=0, 0≦t≦T,y>0,
v(T,x,y)=0, x≦y<x+a. [9]
Based on equations [8] and [9], the price of the crash option can be solved numerically.

Once the price of the absolute value crash option has been set, the option can be sold to an investor, and the predetermined payoff amount can be paid to the investor in the event of a market crash. Otherwise, if a market crash does not occur before the absolute value crash option matures, the option expires as worthless.

In some embodiments, rather than contractually entering into an absolute value crash option, an investor may alternatively choose to invest in an actively traded portfolio with the intention to replicate or mimic the payoff of the absolute value crash option. In this case, a financial institution can set up a portfolio using the hedge of the absolute value crash option. The hedge of the absolute value crash option can be given by vₛ(t,Sₜ,Mₜ), the standard delta hedge, which is the first derivative with respect to the price of the absolute value crash option shown above. The final value of this portfolio can be the same or similar to the payoff of the absolute value crash option.

Other embodiments of the crash option can define the market crash in terms of a relative change in value, i.e., a percentage change. This type of a crash option will hereinafter be called a “relative value crash option.” The relative value crash option can be determined as the first time the stock price drops by percentage a* from its running maximum, and can be represented by
T*ₐ=inf{t≧0:(1−a*)Mₜ≧Sₜ} [10]
wherein 0<a*<1.

In this case, the payoff of the relative value crash option can be defined as
a*M_{T*}_{ₐ}, [11]
which occurs at the time of the market crash T*ₐ, provided the market crashes before the maturity of the contract (T).

Accordingly, the price of the relative value crash option can be determined by representing its value as shown below:
v(t,x,y)=a*E[e^{-r(T*}^{ₐ}^{-t)}I(T*ₐ<T)M_{T*}_{ₐ}|Sₜ=x,Mₜ=y], [12]
under the condition that the option is still alive (i.e., the crash has not happened by time t). Similarly, we obtain

$${v}_{t} ( t , x , y ) + r x {v}_{x} ( t , x , y ) + \frac{1}{2} {σ}^{2} {x}^{2} {v}_{xx} ( t , x , y ) = r v ( t , x , y ) , \qquad [ 13 ]$$

where the equation is satisfied in the region

$$\{ ( t , x , y ) ; 0 \leq t < T , x \leq y \leq \frac{1}{1 - {a}^{*}} x \} ,$$

and the boundary conditions become

$$\begin{matrix} v ( t , ( 1 - {a}^{*} ) y , y ) = {a}^{*} y , & 0 \leq t \leq T , y > 0 , \\ {v}_{y} ( t , y , y ) = 0 , & 0 \leq t \leq T , y > 0 , \\ v ( T , x , y ) = 0 , & x \leq y < \frac{1}{1 - {a}^{*}} x .\end{matrix} \qquad [ 14 ]$$

Since this equation satisfies the linear scaling property
v(t,λx,λy)=λv(t,x,y), [15]
introducing the function u, as shown below, can reduce the dimensionality of the problem:
u(t,z)=v(t,z,1), 0≦t≦T, 1−a*≦z≦1. [16]

Then

$$v ( t , x , y ) = y u ( t , \frac{x}{y} ) . \qquad [ 17 ]$$

It can be verified that u satisfies

$${u}_{t} ( t , z ) + r z {u}_{z} ( t , z ) + \frac{1}{2} {σ}^{2} {z}^{2} {u}_{zz} ( t , z ) = r u ( t , z ) \\ 0 \leq t \leq T , 1 - {a}^{*} \leq z \leq 1 , \qquad [ 18 ]$$

with the boundary conditions
u(T,z)=0, 1−a*<z≦1,
u(t,1)=u_{z}(t,1), 0≦t<T,
u(t,1−a*)=a*, 0≦t≦T. [19]
Based on equations [17] through [19], the price of the crash option can be solved numerically.

Once the price of the relative value crash option has been set, the option can be sold to an investor, and the predetermined payoff amount can be paid to the investor in the event of a market crash. Otherwise, if a market crash does not occur before the relative value crash option matures, the option expires as worthless.

In some embodiments, rather than contractually entering into a relative value crash option, an investor may alternatively choose to invest in an actively traded portfolio with the intention to replicate or mimic the payoff of the relative value crash option. In this case, a financial institution can set up a portfolio using the hedge of the relative value crash option. The hedge of the relative value crash option can be given by vₛ(t,Sₜ,Mₜ), the standard delta hedge, which is the first derivative with respect to the price of the relative value crash option shown above. The final value of this portfolio can be the same or similar to the payoff of the relative value crash option.

Other embodiments of the crash option can define the market crash in terms of an absolute value maximum drawdown. This type of crash option will hereinafter be called an “absolute value maximum drawdown crash option.” The absolute value maximum drawdown Dₜ may be defined as the largest absolute drop of the asset with respect to its running maximum up to time t:

$${D}_{t} = {max}_{u \leq t} [ {M}_{u} - {S}_{u} ] , \qquad [ 20 ]$$

where

$${M}_{t} = {max}_{u \leq t} {S}_{u} .$$

It should be noted that different forms of Mₜ may be defined. For example,

$${M}_{t} = {max}_{t - δ \leq u \leq t} {S}_{u} ,$$

which may look at maximum asset value within a given time interval rather than the maximum asset value obtained during the lifetime of the contract. Moreover, it may also be possible to consider taking the maximum asset value from discretely sampled asset values rather than from continuous price feeds.

In this case, the absolute value maximum drawdown crash option can be defined as a contract which pays off an amount a at the time of the market crash Tₐ, where Tₐ=min{t≧0:Dₜ≧a}, provided the market crash occurs before the maturity of the contract. In such embodiments, the absolute value maximum drawdown crash option can function similarly to the absolute value crash option.

Alternatively, provided the market crash occurs before the maturity of the contract, the absolute value maximum drawdown crash option may maintain a record of the absolute value maximum drawdown during the lifetime of the contract, and pay off the maximum value at the end of the contract lifetime rather than at the time of the crash.

The price, v(t,Sₜ,Mₜ,Dₜ), of the absolute value maximum drawdown crash option can be determined by taking the conditional expectation of the discounted payoff under the risk neutral measure:
v(t,Sₜ,Mₜ,Dₜ)=E[e^{-(T-t)}f({Dᵤ}ᵤ₌₀^{T})|Sₜ,Mₜ,Dₜ], [21]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the absolute value maximum drawdown crash option has been set, the option can be sold to an investor, and the predetermined payoff amount can be paid to the investor in the event of a market crash. Otherwise, if a market crash does not occur before the absolute value maximum drawdown crash option matures, the option expires as worthless.

In some embodiments, rather than contractually entering into an absolute value maximum drawdown crash option, an investor may alternatively choose to invest in an actively traded portfolio with the intention to replicate or mimic the payoff of the absolute value maximum drawdown crash option. In this case, a financial institution can set up a portfolio using the hedge of the absolute value maximum drawdown crash option. The hedge of the absolute value maximum drawdown crash option can be given by vₛ(t,Sₜ,Mₜ,Dₜ), the standard delta hedge, which is the first derivative with respect to the price of the absolute value maximum drawdown crash option shown above. The final value of this portfolio can be the same or similar to the payoff of the absolute value maximum drawdown crash option.

Other embodiments of the crash option can define the market crash in terms of a relative value maximum drawdown. This type of crash option will hereinafter be called a “relative value maximum drawdown crash option.” The relative value maximum drawdown Rₜ can be defined as the largest relative drop of the asset with respect to its running maximum up to time t:

$${R}_{t} = {max}_{u \leq t} \frac{{S}_{u}}{{M}_{u}} . \qquad [ 22 ]$$

In this case, the relative value maximum drawdown crash option can be defined as a contract which pays off an amount a*·M_{T}_{_{a*}}, at the time of the market crash T_{a*}, where T_{a*}=min{t≧0:Rₜ≧1−a*}, provided the market crash occurs before the maturity of the contract. In such embodiments, the relative value maximum drawdown crash option can function similarly to the relative value crash option.

Alternatively, provided the market crash occurs before the maturity of the contract, the relative value maximum drawdown crash option may maintain a record of the relative value maximum drawdown during the lifetime of the contract, and pay off the maximum relative value at the end of the contract lifetime rather than at the time of the market crash event.

The price, v(t,Sₜ,Mₜ,Rₜ), of the relative value maximum drawdown crash option can be determined by taking the conditional expectation of the discounted payoff under the risk neutral measure:
v(t,Sₜ,Mₜ,Rₜ)=E[e^{-(T-t)}f({Rᵤ}ᵤ₌₀^{T})|Sₜ,Mₜ,Rₜ], [23]
where f is the payoff function. This expectation may be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the relative value maximum drawdown crash option has been set, the option can be sold to an investor, and the predetermined payoff amount can be paid to the investor in the event of a market crash. Otherwise, if a market crash does not occur before the relative value maximum drawdown crash option matures, the option expires as worthless.

In some embodiments, rather than contractually entering into a relative value maximum drawdown crash option, an investor may alternatively choose to invest in an actively traded portfolio with the intention to replicate or mimic the payoff of the relative value maximum drawdown crash option. In this case, a financial institution can set up a portfolio using the hedge of the relative value maximum drawdown crash option. The hedge of the relative value maximum drawdown crash option can be given by vₛ(t,Sₜ,Mₜ,Rₜ), the standard delta hedge, which is the first derivative with respect to the price of the relative value maximum drawdown crash option shown above. The final value of this portfolio can be the same or similar to the payoff of the relative value maximum drawdown crash option.

Other embodiments of the crash option can define the market crash in terms of an absolute value average drawdown. This type of crash option will hereinafter be called an “absolute value average drawdown crash option.” The absolute value average drawdown ADₜ may be defined as the average drop of the asset with respect to its running maximum up to time t:

$${AD}_{t} = {average}_{u \leq t} [ {M}_{u} - {S}_{u} ] , where {M}_{t} = {max}_{u \leq t} {S}_{u} . \qquad [ 24 ]$$

The average can be sampled either continuously or discretely (i.e., using a finite number of points). For example, a continuous absolute value average drawdown can be defined as

$${AD}_{t} = \frac{1}{t} {\int }_{0}^{t} [ {M}_{u} - {S}_{u} ] ⅆ u \qquad [ 25 ]$$

whereas a discrete absolute value average drawdown can be defined as

$${AD}_{t} = \frac{1}{n} {\sum }_{i = 1}^{n} [ {M}_{\frac{it}{n}} - {S}_{\frac{it}{n}} ] . \qquad [ 26 ]$$

Other averaging embodiments, such as using a weighted average, should be readily apparent to one of ordinary skill in the art.

In this case, the absolute value average drawdown crash option can be defined as a contract which pays off an amount a at the time of the market crash Tₐ, where Tₐ=min{t≧0:ADₜ≧a}, provided the market crash occurs before the maturity of the contract.

Alternatively, provided the market crash occurs before the maturity of the contract, the absolute value average drawdown crash option may maintain a record of the absolute value average drawdown during the lifetime of the contract, and pay off the average absolute value at the end of the contract lifetime rather than at the time of the market crash event.

The price, v(t,Sₜ,Mₜ,ADₜ), of the absolute value average drawdown crash option can be determined by taking the conditional expectation of the discounted payoff under the risk neutral measure:
v(t,Sₜ,Mₜ,ADₜ)=E[e^{-(T-t)}f({ADᵤ}ᵤ₌₀^{T})|Sₜ,Mₜ,ADₜ] [27]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the absolute value average drawdown crash option has been set, the option can be sold to an investor, and the predetermined payoff amount can be paid to the investor in the event of a market crash. Otherwise, if a market crash does not occur before the absolute value average drawdown crash option matures, the option expires as worthless.

In some embodiments, rather than contractually entering into an absolute value average drawdown crash option, an investor may alternatively choose to invest in an actively traded portfolio with the intention to replicate or mimic the payoff of the absolute value average drawdown crash option. In this case, a financial institution can set up a portfolio using the hedge of the absolute value average drawdown crash option. The hedge of the absolute value average drawdown crash option can be given by vₛ(t,Sₜ,Mₜ,ADₜ), the standard delta hedge, which is the first derivative with respect to the price of the absolute value average drawdown crash option shown above. The final value of this portfolio can be the same or similar to the payoff of the absolute value average drawdown crash option.

Other embodiments of the crash option can define the market crash in terms of a relative value average drawdown. This type of crash option will hereinafter be called a “relative value average drawdown crash option.” The relative value average drawdown ARₜ can be defined as the average relative drop of the asset with respect to its running maximum up to time t:

$${AR}_{t} = {average}_{u \leq t} \frac{{S}_{u}}{{M}_{u}} . \qquad [ 28 ]$$

In this case, the relative value average drawdown crash option can be defined as a contract which pays off an amount a*·M_{T}_{_{a*}}, at the time of the market crash T_{a*}, where T_{a*}=min{t≧0:ARₜ≧1−a*}, provided the market crash occurs before the maturity of the contract.

Alternatively, provided the market crash occurs before the maturity of the contract, the relative value average drawdown crash option may maintain a record of the relative value average drawdown during the lifetime of the contract, and pay off the average relative value at the end of the contract lifetime rather than at the time of the market crash event.

The price, v(t,Sₜ,Mₜ,ARₜ), of the relative value average drawdown crash option can be determined by taking the conditional expectation of the discounted payoff under the risk neutral measure:
v(t,Sₜ,Mₜ,ARₜ)=E[e^{-(T-t)}f({ARᵤ}ᵤ₌₀^{T})|Sₜ,Mₜ,ARₜ], [29]
where f is the payoff function. This expectation may be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the relative value average drawdown crash option has been set, the option can be sold to an investor, and the predetermined payoff amount can be paid to the investor in the event of a market crash. Otherwise, if a market crash does not occur before the relative value average drawdown crash option matures, the option expires as worthless.

In some embodiments, rather than contractually entering into a relative value average drawdown crash option, an investor may alternatively choose to invest in an actively traded portfolio with the intention to replicate or mimic the payoff of the relative value average drawdown crash option. In this case, a financial institution can set up a portfolio using the hedge of the relative value average drawdown crash option. The hedge of the relative value average drawdown crash option can be given by vₛ(t,Sₜ,Mₜ,ARₜ), the standard delta hedge, which is the first derivative with respect to the price of the relative value average drawdown crash option shown above. The final value of this portfolio can be the same or similar to the payoff of the relative value average drawdown crash option.

Crash Index

In some embodiments of the present invention, a method for providing an investor with a market perception of a probability of a future market crash is provided. The method includes: 1) defining a market crash index; 2) calculating the market crash index; 3) providing the market crash index to an investor; and 4) collecting revenue if an investor enters one or more futures or options contracts on the market crash index. Alternatively, the market crash index may be used as an alternative measure of market rating.

Certain embodiments of providing an investor with a market perception of a probability of a future market crash can be to define a market crash index as a Market Price of Crash Index. This may be represented in various embodiments, such as, but not specifically limited to,
MPCI¹(a,T)=P(Tₐ<T), [30]
which can indicate the probability that a crash of a size a will occur by time T. Other embodiments include defining a Market Price of Crash Index as
MPCI²(a,T)=E[e^{-rT}^{ₐ}I(Tₐ<T)], [31]
which is a discounted version of MPCI¹(a,T) and can be proportional to the previously described price of an absolute value crash option. Other embodiments include defining a Market Price of Crash Index as
MPCI³(a*,T)=P(T*_{a*}<T), [32]
which can indicate the probability that a crash of a percentage a* will occur by time T. Other embodiments include defining a Market Price of Crash Index as
MPCI⁴(a*,T)=E[e^{-rT*}^{_{a*}}I(T*_{a*}<T)] [33]
which is a discounted version of MPCI³(a*,T). This index can be proportional to the previously described price of a relative value crash option.

To compute the Market Price of Crash Index, probability measures such as, for example, a real market measure and a risk neutral measure (which is used for pricing financial derivatives, and may effectively give the cost of replicating specific market events) can be considered.

A real market measure can give probabilities of events as viewed by the market. For example, if a diffusion model is assumed for stocks, the stock price evolution can be represented as a geometric Brownian motion with drift μ as shown below:
dSₜ=Sₜ(μdt+σdWₜ) [34]
where the drift parameter μ can be inferred from historical data of the market.

A risk neutral measure can provide replicating costs of contingent claims traded in the market. This can enable pricing contingent claims as discounted expected payoffs. Assuming a diffusion model for stocks, risk neutral dynamics of an asset may be given by
dSₜ=Sₜ(rdt+σdWₜ) [35]

It should be noted that the difference between the real market measure and the risk neutral measure is in the drift term. For a detailed discussion on the relationship between the two measures, Shreve, S., “Stochastic Calculus for Finance II,” Springer-Verlag, 2004, can be referenced.

In certain embodiments, MPCI² and MPCI⁴ can be quoted by using the risk neutral measure expectation, as they may be directly seen from the prices of the corresponding crash options.

In yet other embodiments, it may be possible to compute MPCI indices without trading the crash options. Currently traded options, such as the American or the European options, may contain sufficient information about transition density of the stock prices to compute various MPCI indices.

Rally Options

In some embodiments of the present invention, a method for providing an investor with a rally option to insure the investor in the event of a market rally is provided. The method includes: 1) defining a market rally event; 2) defining a rally option contract which pays off a certain payoff amount if the market rally event occurs; 3) pricing the rally option; 4) selling the rally option to an investor; and 5) paying off the predetermined payoff amount to the investor if the market rally event occurs or not paying off the predetermined payoff amount (i.e., the rally option expires as worthless) if the market rally event does not occur during the lifetime of the contract.

Certain embodiments of the rally option define the event of a market rally as an absolute value. This type of rally option will hereinafter be called an “absolute value rally option.” An absolute value market rally can be defined as the first time the stock price Sₜ increases by a constant b from its running minimum. This can be represented by
T_{b}=inf{t≧0:Sₜ−mₜ≧b}, [36]
where

$${m}_{t} = {inf}_{s \leq t} {S}_{s} and b > 0.$$

Asset Sₜ may be any asset, such as a stock price, an interest rate, an exchange rate, or the like. It should be noted that different forms of mₜ may be defined. For example,

$${m}_{t} = {inf}_{t - δ \leq s \leq t} {S}_{s} ,$$

which may look at minimum asset value within a given time interval rather than the minimum asset value obtained during the lifetime of the contract. Moreover, it may also be possible to consider taking the minimum asset value from discretely sampled asset values rather than from continuous asset value feeds.

In this case, the rally option can be defined as a contract which pays off an amount b at the time of a market rally T_{b}, provided the market rally occurs before the contract matures.

Other payoffs may include, for example, S_{T}_{_{b}}−m_{T}_{_{b}} (if the price increase does not occur in a continuous manner and thus may not equal b) or a running average of the price up to time T_{b}. These examples are not meant to be limiting, as other payoff possibilities will readily be apparent to one of ordinary skill in the art.

Furthermore, the price of the absolute value rally option can be determined by defining the value of the absolute value rally option at time t, under the condition that the option is still alive (i.e., the market rally has not happened by time t) as shown below:
v(t,x,y)=bE[e^{-rT}^{_{b}}I(T_{b}<T)Sₜ=x,mₜ=y]. [37]
The corresponding partial differential equation is the same as in the absolute value crash option, and we obtain

$${v}_{t} ( t , x , y ) + r x {v}_{x} ( t , x , y ) + \frac{1}{2} {σ}^{2} {x}^{2} {v}_{xx} ( t , x , y ) = r v ( t , x , y ) \qquad [ 38 ]$$

in the region {(t,x,y); 0≦t<T, x−b≦y≦x}. The equation satisfies the boundary condition
v(t,x,0)=0, 0≦t≦T,x<b,
v(t,y+b,y)=b, 0≦t≦T,y>0,
v_{y}(t,y,y)=0, 0≦t≦T,y>0,
v(T,x,y)=0, x−b<y≦x. [39]
Based on equations [38] and [39], the price of the rally option can be solved numerically.

Once the price of the absolute value rally option has been set, the option can be sold to an investor, and the predetermined payoff amount can be paid to the investor in the event of a market rally. Otherwise, if a market rally does not occur before the rally option matures, the option expires as worthless.

In some embodiments, rather than contractually entering into an absolute value rally option, an investor may alternatively choose to invest in an actively traded portfolio with the intention to replicate or mimic the payoff of the absolute value rally option. In this case, a financial institution can set up a portfolio using the hedge of the absolute value rally option. The hedge of the absolute value rally option can be given by vₛ(t,Sₜ,mₜ), the standard delta hedge, which is the first derivative with respect to the price of the absolute value rally option shown above. The final value of this portfolio can be the same or similar to the payoff of the absolute value rally option.

Other embodiments of the rally option define the market rally in terms of a relative change in value, i.e., a percentage change. This type of rally option will hereinafter be called a “relative value rally option.” A relative value market rally can be determined to be the first time the stock price increases by percentage b* from its running minimum, and can be represented by
T*_{b}=inf{t≧0:Sₜ≧(1+b*)mₜ}, [40]
where b*>0.

In this case, the payoff of the relative value rally option can be defined as
b*m_{T*}_{_{b}}, [41]
which occurs at the time of the market rally T*_{b}, provided the market rallies before the maturity of the contract (T).

Accordingly, the price of the relative value rally option can be determined by representing its value as shown below:
v(t,x,y)=b*E[e^{-r(T*}^{_{b}}^{-t)}I(T*_{b}<T)m_{T*}_{_{b}}|Sₜ=x,mₜ=y], [42]
under the condition that the option is still alive (i.e., the market rally has not happened by time t). Similarly, we obtain

$${v}_{t} ( t , x , y ) + r x {v}_{x} ( t , x , y ) + \frac{1}{2} {σ}^{2} {x}^{2} {v}_{xx} ( t , x , y ) = r v ( t , x , y ) , \qquad [ 43 ]$$

where the equation is satisfied in the region

$$\{ ( t , x , y ) ; 0 \leq t < T , \frac{1}{1 + {b}^{*}} x \leq y \leq x \} ,$$

and the boundary conditions become

$$\begin{matrix}v ( t , ( 1 + {b}^{*} ) y , y ) = {b}^{*} y , & 0 \leq t \leq T , y > 0 , \\ {v}_{y} ( t , y , y ) = 0 , & 0 \leq t \leq T , y > 0 , \\ v ( T , x , y ) = 0 , & \frac{1}{1 + {b}^{*}} x \leq y \leq x .\end{matrix} \qquad [ 44 ]$$

Since the relative value crash option satisfies the linear scaling property
v(t,λx,λy)=λv(t,x,y), [45]
the dimensionality of the problem can be reduced by introducing function u by

$$\begin{matrix}\begin{matrix}u ( t , z ) = v ( t , z , 1 ) , & 0 \leq t \leq T , 1 \leq z \leq 1 + {b}^{*} .\end{matrix} \\ Then & [ 46 ] \\ v ( t , x , y ) = yu ( t , \frac{x}{y} ) . & [ 47 ]\end{matrix}$$

It can be verified that u satisfies

$${u}_{t} ( t , z ) + {rzu}_{z} ( t , z ) + \frac{1}{2} {σ}^{2} {z}^{2} {u}_{zz} ( t , z ) = ru ( t , z ) \\ 0 \leq t \leq T , 1 \leq z \leq 1 + {b}^{*} , \qquad [ 48 ]$$

with the boundary conditions
u(T,z)=0, 1≦z<1+b*,
u(t,1)=u_{z}(t,1), 0≦t<T,
u(t,1+b*)=b*, 0≦t≦T. [49]
Based on equations [47] through [49], the price of the rally option can be solved numerically.

Once the price of the relative value rally option has been set, the option can be sold to an investor, and the predetermined payoff amount can be paid to the investor in the event of a market rally. Otherwise, if a market rally does not occur before the relative value rally option matures, the option expires as worthless.

In some embodiments, rather than contractually entering into a relative value rally option, an investor may alternatively choose to invest in an actively traded portfolio with the intention to replicate or mimic the payoff of the relative value rally option. In this case, a financial institution can set up a portfolio using the hedge of the relative value rally option. The hedge of the relative value rally option can be given by vₛ(t,Sₜ,mₜ), the standard delta hedge, which is the first derivative with respect to the price of the relative value rally option shown above. The final value of this portfolio can be the same or similar to the payoff of the relative value rally option.

Other embodiments of the rally option may define the event of a market rally as an absolute value maximum drawup. This type of rally option will hereinafter be called an “absolute value maximum drawup rally option.” The absolute value maximum drawup dₜ may be defined as the largest absolute increase of the asset with respect to its running minimum up to time t:

$${d}_{t} = {max}_{u \leq t} [ {S}_{u} - {m}_{u} ] \qquad [ 50 ]$$

wherein

$${m}_{t} = {min}_{u \leq t} {S}_{u} .$$

Asset Sᵤ may be any asset, such as a stock price, an interest rate, an exchange rate, or the like. It should be noted that different forms of mₜ may be defined. For example,

$${m}_{t} = {min}_{t - δ \leq s \leq t} {S}_{u} ,$$

which may look at minimum asset value within a given time interval rather than the minimum asset value obtained during the lifetime of the contract. Moreover, it may also be possible to consider taking the minimum asset value from discretely sampled asset values rather than from continuous asset value feeds.

In this case, the rally option can be defined as a contract which pays off an amount b at the time of the market rally T_{b}, where T_{b}=min{t≧0:dₜ≧b}, provided the market rally occurs before the contract matures. In such embodiments, the absolute value maximum drawup rally option functions similarly to the absolute value rally option.

Alternatively, provided the market rally occurs before the maturity of the contract, the absolute value maximum drawup rally option may maintain a record of the absolute value maximum drawup during the lifetime of the contract, and pay off the maximum value at the end of the contract lifetime rather than at the time of the market rally event.

The price, v(t,Sₜ,mₜ,dₜ), of the absolute value maximum drawup rally option can be determined by taking the conditional expectation of the discounted payoff under the risk neutral measure:
v(t,Sₜ,mₜ,dₜ)=E[e^{-(T-t)}f({dᵤ}ᵤ₌₀^{T})|Sₜ,mₜ,dₜ], [51]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the absolute value maximum drawup rally option has been set, the option can be sold to an investor, and the predetermined payoff amount can be paid to the investor in the event of a market rally. Otherwise, if a market rally does not occur before the absolute value maximum drawup rally option matures, the option expires as worthless.

In some embodiments, rather than contractually entering into an absolute value maximum drawup rally option, an investor may alternatively choose to invest in an actively traded portfolio with the intention to replicate or mimic the payoff of the absolute value maximum drawup rally option. In this case, a financial institution can set up a portfolio using the hedge of the absolute value maximum drawup rally option. The hedge of the absolute value maximum drawup rally option can be given by vₛ(t,Sₜ,mₜ,dₜ), the standard delta hedge, which is the first derivative with respect to the price of the absolute value maximum drawup rally option shown above. The final value of this portfolio can be the same or similar to the payoff of the absolute value maximum drawup rally option.

Other embodiments of the rally option can define the market rally in terms of a relative value maximum drawup. This type of an option will hereinafter be called a “relative value maximum drawup rally option.” The relative value maximum drawup rₜ may be defined as the largest relative increase of the asset with respect to its running minimum up to time t:

$${r}_{t} = {max}_{u \leq t} \frac{{S}_{u}}{{m}_{u}} . \qquad [ 52 ]$$

In this case, the relative value maximum drawup rally option can be defined as a contract, which pays off an amount b*·m_{T}_{_{b*}}, at the time of the market rally T_{b}*, where T_{b*}=min{t≧0:rₜ≧1+b*}, provided the market rally occurs before the maturity of the contract.

The price, v(t,Sₜ,mₜ,rₜ), of the relative value maximum drawup rally option can be determined by taking the conditional expectation of the discounted payoff under the risk neutral measure:
v(t,Sₜ,mₜ,rₜ)=E[e^{-(T-t)}f({rᵤ}ᵤ₌₀^{T})|S_{y},mₜ,rₜ], [53]
where f is the payoff function. This expectation can be computed by using standard Monte Carlo simulations. The pricing via condition expectations can be linked to partial differential equations through Feynman-Kac theorem, as can be found, for example, in Shreve, S., “Stochastic Calculus for Finance II,” Springer-Verlag, 2004, and solved numerically.

Once the price of the relative value maximum drawup rally option has been set, the option can be sold to an investor, and the predetermined payoff amount can be paid to the investor in the event of a market rally. Otherwise, if a market rally does not occur before the relative value maximum drawup rally option matures, the option expires as worthless.

In some embodiments, rather than contractually entering into the relative value maximum drawup rally option, an investor may alternatively choose to invest in an actively traded portfolio with the intention to replicate or mimic the payoff of the relative value maximum drawup rally option. In this case, a financial institution can set up a portfolio using the hedge of the relative value maximum drawup rally option. The hedge of the relative value maximum drawup rally option can be given by vₛ(t,Sₜ,mₜ,rₜ), the standard delta hedge, which is the first derivative with respect to the price of the relative value maximum drawup rally option shown above. The final value of this portfolio can be the same or similar to the payoff of the relative value maximum drawup rally option.

Other embodiments of the crash option can define the market rally in terms of an absolute value average drawup. This type of crash option will hereinafter be called an “absolute value average drawup rally option.” The absolute value average drawup ad, may be defined as the average increase of the asset with respect to its running minimum up to time t:

$${ad}_{t} = {average}_{u \leq t} [ {S}_{u} - {m}_{u} ] , \qquad [ 54 ]$$

where

$${m}_{t} = {min}_{u \leq t} {S}_{u} .$$

The average can be sampled either continuously or discretely (i.e., using a finite number of points). For example, a continuous absolute value average drawup can be defined as

$${ad}_{t} = \frac{1}{t} {\int }_{0}^{t} [ {S}_{u} - {m}_{u} ] ⅆ u \qquad [ 55 ]$$

whereas a discrete absolute value average drawup can be defined as

$${ad}_{t} = \frac{1}{n} {\sum }_{i = 1}^{n} [ {S}_{\frac{it}{n}} - {m}_{\frac{it}{n}} ] . \qquad [ 56 ]$$

Other averaging embodiments, such as using a weighted average, should be readily apparent to one of ordinary skill in the art.

In this case, the absolute value average drawup rally option can be defined as a contract which pays off an amount b at the time of the market rally T_{b}, where T_{b}=min{t≧0:adₜ≧b}, provided the market rally occurs before the maturity of the contract.

Alternatively, provided the market rally occurs before the maturity of the contract, the absolute value average drawup rally option may maintain a record of the absolute value average drawup during the lifetime of the contract, and pay off the average absolute value at the end of the contract lifetime rather than at the time of the market rally event.

The price, v(t,Sₜ,mₜ,adₜ), of the absolute value average drawup rally option can be determined by taking the conditional expectation of the discounted payoff under the risk neutral measure:
v(t,Sₜ,mₜ,adₜ)=E[e^{-(T-t)}f({adᵤ}ᵤ₌₀^{T})|Sₜmₜ,adₜ], [57]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the absolute value average drawup rally option has been set, the option can be sold to an investor, and the predetermined payoff amount can be paid to the investor in the event of a market rally. Otherwise, if a market rally does not occur before the absolute value average drawup rally option matures, the option expires as worthless.

In some embodiments, rather than contractually entering into an absolute value average drawup rally option, an investor may alternatively choose to invest in an actively traded portfolio with the intention to replicate or mimic the payoff of the absolute value average drawup rally option. In this case, a financial institution can set up a portfolio using the hedge of the absolute value average drawup rally option. The hedge of the absolute value average drawup rally option can be given by vₛ(t,Sₜ,mₜ,adₜ), the standard delta hedge, which is the first derivative with respect to the price of the absolute value average drawup rally option shown above. The final value of this portfolio can be the same or similar to the payoff of the absolute value average drawup rally option.

Other embodiments of the crash option can define the market crash in terms of a relative value average drawup. This type of crash option will hereinafter be called a “relative value average drawup rally option.” The relative value average drawup arₜ can be defined as the average relative increase of the asset with respect to its running minimum up to time t:

$${ar}_{t} = {average}_{u \leq t} \frac{{S}_{u}}{{m}_{u}} . \qquad [ 58 ]$$

In this case, the relative value average drawup rally option can be defined as a contract which pays off an amount b*·m_{T}_{_{b*}}, at the time of the market rally T_{b*}, where T_{b*}=min{t≧0:arₜ≧1+b*}, provided the market rally occurs before the maturity of the contract.

Alternatively, provided the market rally occurs before the maturity of the contract, the relative value average drawup rally option may maintain a record of the relative value average drawup during the lifetime of the contract, and pay off the average relative value at the end of the contract lifetime rather than at the time of the market rally event.

The price, v(t,Sₜ,mₜ,arₜ), of the relative value average drawup rally option can be determined by taking the conditional expectation of the discounted payoff under the risk neutral measure:
v(t,Sₜ,mₜ,arₜ)=E[e^{-(T-t)}f({arᵤ}ᵤ₌₀^{T})|Sₜ,mₜ,arₜ], [59]
where f is the payoff function. This expectation may be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the relative value average drawup rally option has been set, the option can be sold to an investor, and the predetermined payoff amount can be paid to the investor in the event of a market rally. Otherwise, if a market rally does not occur before the relative value average drawup rally option matures, the option expires as worthless.

In some embodiments, rather than contractually entering into a relative value average drawup rally option, an investor may alternatively choose to invest in an actively traded portfolio with the intention to replicate or mimic the payoff of the relative value average drawup rally option. In this case, a financial institution can set up a portfolio using the hedge of the relative value average drawup rally option. The hedge of the relative value average drawup rally option can be given by vₛ(t,Sₜ,mₜ,arₜ), the standard delta hedge, which is the first derivative with respect to the price of the relative value average drawup rally option shown above. The final value of this portfolio can be the same or similar to the payoff of the relative value average drawup rally option.

Rally Index

In some embodiments of the present invention, a method for providing an investor with a market perception of a probability of a future market rally is provided. The method includes: 1) defining a market rally index; 2) calculating the market rally index; 3) providing the market rally index to an investor; and 4) collecting revenue if an investor enters into one or more futures or options contracts on the market rally index. Alternatively, the market rally index may be used as an alternative measure of market rating.

Certain embodiments of providing an investor with a market perception of a probability of a future market rally can be to define an index as a Market Price of Rally Index. This can be represented in various embodiments, such as, but not specifically limited to,
MPRI¹(b,T)=P(T_{b}<T), [60]
which may indicate the probability that a rally of a size b will occur by time T. Other embodiments include defining a Market Price of Rally Index as
MPRI²(b,T)=E[e^{-rT}^{_{b}}I(T_{b}<T)], [61]
which is a discounted version of MPRI¹(b,T) and can be proportional to the previously described price of an absolute value rally option. Other embodiments include defining a Market Price of Rally Index as
MPRI³(b*,T)=P(T_{b*}<T), [62]
which indicates the probability that a rally of a percentage b* will occur by time T. Other embodiments include defining a Market Price of Rally Index as
MPRI⁴(b*,T)=E[e^{-rT}^{_{b*}}I(T_{b*}<T)] [63]
which is a discounted version of MPRI³(b*,T). This index can be proportional to the previously described price of a relative value rally option.

To compute the Market Price of Rally Index, probability measures such as, for example, a real market measure and a risk neutral measure (which is used for pricing financial derivatives, and may effectively give the cost of replicating specific market events) can be considered.

A real market measure may give probabilities of events as viewed by the market. For example, if a diffusion model is assumed for stocks, the stock price evolution can be represented as a geometric Brownian motion with drift μ as shown below:
dSₜ=Sₜ(μdt+σdWₜ) [64]
wherein the drift parameter μ may be inferred from historical data of the market.

A risk neutral measure can provide replicating costs of contingent claims traded in the market. This can enable pricing contingent claims as discounted expected payoffs. Assuming a diffusion model for stocks, risk neutral dynamics of an asset may be given by
dSₜ=Sₜ(rdt+σdWₜ) [65]

It should be noted that the difference between the real market measure and the risk neutral measure is in the drift term. For a detailed discussion on the relationship between the two measures, Shreve, S., “Stochastic Calculus for Finance II,” Springer-Verlag, 2004, may be consulted.

In certain embodiments, MPRI² and MPRI⁴ can be quoted by using the risk neutral measure expectation, as they may be directly seen from the prices of the corresponding rally options.

In yet other embodiments, it may be possible to compute MPRI indices without trading the rally options. Currently traded options, such as the American or the European options, may contain sufficient information about transition density of the stock prices to compute various MPRI indices.

Range Options

In some embodiments of the present invention, a method for providing an investor with a range option is provided. The method includes: 1) defining a range event; 2) defining a range option contract which pays off a certain payoff amount if the range event occurs; 3) pricing the range option; 4) selling the range option to an investor; and 5) paying off the predetermined payoff amount to the investor if the range event occurs or not paying off the predetermined payoff amount (i.e., the range option expires as worthless) if the range event does not occur during the lifetime of the contract.

Certain embodiments of the range option may define a range event as the first time an asset exceeds a range of the level a. This can be represented by
Uₐ=inf{t≧0:Mₜ−mₜΔa}. [66]

In this case, the range option can be defined as a contract which pays off an amount a at the time of the range event Uₐ, provided the range event occurs before the maturity of the contract.

It should be noted that other payoffs may be considered. Other payoffs may include, for example, M_{Ua}−m_{U}_{ₐ}. These payoff examples are not meant to be limiting, as other payoff possibilities will readily be apparent to one of ordinary skill in the art.

Furthermore, the price of the range option at time t can be determined by the following equation:
v(t,x,y,z)=aE[e^{-r(U}^{ₐ}^{-t)}I(Uₐ<T)|Sₜ=x,Mₜ=y,mₜ=z]. [67]
The corresponding partial differential equation can be obtained and is represented by

$${v}_{t} ( t , x , y , z ) + {rxv}_{x} ( t , x , y , z ) + \frac{1}{2} {σ}^{2} {x}^{2} {v}_{xx} ( t , x , y , z ) = rv ( t , x , y , z ) \qquad [ 68 ]$$

defined in the region {(t,x,y,z); 0≦t<T, 0≦z≦x≦y≦z+a and the equation satisfies the boundary condition
v_{y}(t,y,y,z)=0, 0≦t≦T,z≦y≦z+a,
v_{z}(t,z,y,z)=0, 0≦t≦T,z≦y≦z+a,
v(t,x,z+a,z)=a, 0≦t≦T,z≦x≦z+a,
v(T,x,y,z)=0, z≦x≦y≦z+a. [69]
Based on equations [68] and [69], the price of the range option can be solved numerically.

Once the price of the range option has been set, the option can be sold to an investor, and the predetermined payoff amount can be paid to the investor in the event of a range event. Otherwise, if a range event does not occur before the range option matures, the option expires as worthless.

In some embodiments, rather than contractually entering into a range option, an investor may alternatively choose to invest in an actively traded portfolio with the intention to replicate or mimic the payoff of the range option. In this case, a financial institution can set up a portfolio using the hedge of the range option. The hedge of the range option can be given by vₛ(t,Sₜ,Mₜ,mₜ), the standard delta hedge, which is the first derivative with respect to the price of the range option shown above. The final value of this portfolio can be the same or similar to the payoff of the range option.

Other embodiments of the range option can define a range event as an absolute value maximum range. This type of range option will hereinafter be called an “absolute value maximum range option.” The absolute value maximum range RNGₜ can be defined as the largest absolute difference between the minimum and maximum of the asset price up to time t:

$${RNG}_{t} = {max}_{u \leq t} [ {M}_{u} - {m}_{u} ] \\ wherein {m}_{t} = {min}_{u \leq t} {S}_{u} and {M}_{t} = {max}_{u \leq t} {S}_{u} . \qquad [ 70 ]$$

In this case, the range option can be defined as a contract which pays off an amount a at the time of the range event Tₐ, where Tₐ=min{t≧0:RNGₜ≧a}, provided the range event occurs before the contract matures. If this is the case, the absolute value maximum range option can function similarly to the range option mentioned above.

Alternatively, provided the range event occurs before the maturity of the contract, the absolute value maximum range option may maintain a record of the absolute value maximum range during the lifetime of the contract, and pay off the maximum value at the end of the contract lifetime rather than at the time of the range event.

The price, v(t,Sₜ,Mₜ,mₜ,RNGₜ), of the absolute value maximum range option can be determined by taking the conditional expectation of the discounted payoff under the risk neutral measure:
v(t,Sₜ,Mₜ,mₜ,RNGₜ)=E[e^{-(T-t)}f(RNGᵤ}ᵤ₌₀^{T})|Sₜ,Mₜ,mₜ,RNGₜ] [71]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the absolute value maximum range option has been set, the option can be sold to an investor, and the predetermined payoff amount can be paid to the investor in the event of a range event. Otherwise, if a range event does not occur before the absolute value maximum range option matures, the option expires as worthless.

In some embodiments, rather than contractually entering into an absolute value maximum range option, an investor may alternatively choose to invest in an actively traded portfolio with the intention to replicate or mimic the payoff of the absolute value maximum range option. In this case, a financial institution can set up a portfolio using the hedge of the absolute value maximum range option. The hedge of the absolute value maximum range option can be given by vₛ(t,Sₜ,Mₜ,mₜ,RNGₜ), the standard delta hedge, which is the first derivative with respect to the price of the absolute value maximum range option shown above. The final value of this portfolio can be the same or similar to the payoff of the absolute value maximum range option.

Other embodiments of the range option can define a range event in terms of a relative value maximum range. This type of range option will hereinafter be called a “relative value maximum range option.” The relative value maximum range rngₜ may be defined as:

$${rng}_{t} = {max}_{u \leq t} \frac{{M}_{u}}{{m}_{u}} . \qquad [ 72 ]$$

In this case, the relative value maximum range option can be defined as a contract which pays off an amount a*·(M_{T}_{_{a*}}−m_{T}_{_{a*}}) at the time of the range event T_{a*}, where T_{a*}=min{t≧0:rngₜ≧a*}, provided the range event occurs before the maturity of the contract.

The price, v(t,Sₜ,Mₜ,mₜ,rngₜ), of the relative value maximum range option can be determined by taking the conditional expectation of the discounted payoff under the risk neutral measure:
v(t,Sₜ,Mₜ,mₜ,rngₜ)=E[e^{-(T-t)}f({rngᵤ}ᵤ₌ₜ^{T})|Sₜ,Mₜ,mₜ,rngₜ] [73]
This expectation may be computed by using standard Monte Carlo simulations. The pricing via conditional expectations can be linked to partial differential equations through Feynman-Kac theorem, as can be found, for instance, in Shreve, S., “Stochastic Calculus for Finance II,” Springer-Verlag, 2004, and solved numerically.

Once the price of the relative value maximum range option has been set, the option can be sold to an investor, and the predetermined payoff amount can be paid to the investor in the event of a range event. Otherwise, if a range event does not occur before the relative value maximum range option matures, the option expires as worthless.

In some embodiments, rather than contractually entering into a relative value maximum range option, an investor may alternatively choose to invest in an actively traded portfolio with the intention to replicate or mimic the payoff of the relative value maximum range option. In this case, a financial institution can set up a portfolio using the hedge of the relative value maximum range option. The hedge of the relative value maximum range option may be given by vₛ(t,Sₜ,Mₜ,mₜ,rngₜ), the standard delta hedge, which is the first derivative with respect to the price of the relative value maximum range option shown above. The final value of this portfolio can be the same or similar to the payoff of the absolute value maximum range option.

Other embodiments of the range option can define a range event as an absolute value average range. This type of range option will hereinafter be called an “absolute value average range option.” The absolute value average range ARNGₜ can be defined as the average absolute difference between the minimum and maximum of the asset price up to time t:

$${ARNG}_{t} = {average}_{u \leq t} [ {M}_{u} - {m}_{u} ] \\ wherein {m}_{t} = {min}_{u \leq t} {S}_{u} and {M}_{t} = {max}_{u \leq t} {S}_{u} . \qquad [ 74 ]$$

In this case, the range option can be defined as a contract which pays off an amount a at the time of the range event Tₐ, where Tₐ=min{t≧0:ARNGₜ≧a}, provided the range event occurs before the contract matures.

Alternatively, provided the range event occurs before the maturity of the contract, the absolute value average range option may maintain a record of the absolute value average range during the lifetime of the contract, and pay off the average value at the end of the contract lifetime rather than at the time of the range event.

The price, v(t,Sₜ,Mₜ,mₜ,ARNGₜ), of the absolute value average range option can be determined by taking the conditional expectation of the discounted payoff under the risk neutral measure:
v(t,Sₜ,Mₜ,mₜ,ARNGₜ)=E[e^{-(T-t)}f({ARNGᵤ}ᵤ₌₀^{T})|Sₜ,Mₜ,mₜ,ARNGₜ], [75]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of the absolute value average range option has been set, the option can be sold to an investor, and the predetermined payoff amount can be paid to the investor in the event of a range event. Otherwise, if a range event does not occur before the absolute value average range option matures, the option expires as worthless.

In some embodiments, rather than contractually entering into an absolute value average range option, an investor may alternatively choose to invest in an actively traded portfolio with the intention to replicate or mimic the payoff of the absolute value average range option. In this case, a financial institution can set up a portfolio using the hedge of the absolute value average range option. The hedge of the absolute value average range option can be given by vₛ(t,Sₜ,Mₜ,mₜ,ARNGₜ), the standard delta hedge, which is the first derivative with respect to the price of the absolute value average range option shown above. The final value of this portfolio can be the same or similar to the payoff of the absolute value average range option.

Other embodiments of the range option can define a range event in terms of a relative value average range. This type of range option will hereinafter be called a “relative value average range option.” The relative value average range arngₜ may be defined as:

$${arng}_{t} = {average}_{u \leq t} \frac{{M}_{u}}{{m}_{u}} . \qquad [ 76 ]$$

In this case, the relative value average range option can be defined as a contract which pays off an amount a*·(M_{T}_{_{a*}}−m_{T}_{_{a*}}) at the time of the range event T_{a*}, where T_{a*}=min{t≧0:arngₜ≧a*}, provided the range event occurs before the maturity of the contract.

The price, v(t,Sₜ,Mₜ,mₜ,arngₜ), of the relative value average range option can be determined by taking the conditional expectation of the discounted payoff under the risk neutral measure:
v(t,Sₜ,Mₜ,mₜ,arngₜ)=E[e^{-(T-t)}f({arngᵤ}ᵤ₌ₜ^{T})|Sₜ,Mₜ,mₜ,arngₜ] [77]
This expectation may be computed by using standard Monte Carlo simulations. The pricing via conditional expectations can be linked to partial differential equations through Feynman-Kac theorem, as can be found, for instance, in Shreve, S., “Stochastic Calculus for Finance II,” Springer-Verlag, 2004, and solved numerically.

Once the price of the relative value average range option has been set, the option can be sold to an investor, and the predetermined payoff amount can be paid to the investor in the event of a range event. Otherwise, if a range event does not occur before the relative value average range option matures, the option expires as worthless.

In some embodiments, rather than contractually entering into a relative value average range option, an investor may alternatively choose to invest in an actively traded portfolio with the intention to replicate or mimic the payoff of the relative value average range option. In this case, a financial institution can set up a portfolio using the hedge of the relative value average range option. The hedge of the relative value average range option may be given by vₛ(t,Sₜ,Mₜ,mₜ,arngₜ), the standard delta hedge, which is the first derivative with respect to the price of the relative value average range option shown above. The final value of this portfolio can be the same or similar to the payoff of the absolute value average range option.

### Other Embodiments

It should be noted that the embodiments described above are illustrative embodiments of the present invention and are not meant to be limiting. Other embodiments of the present invention are possible.

Embodiments Based on Absolute Value Maximum Drawdown

Any financial contract that depends on the process {Dₜ}ₜ₌₀^{T} may be viewed as a contingent claim depending on the absolute value maximum drawdown Dₜ. Examples of such financial contracts include a forward or futures contract having a payoff of D_{T}−K, a call option having a payoff of (D_{T}−K)⁺, and a put option having a payoff of (K−D_{T})⁺, where K is the strike price of the asset.

Alternatively, the average of the absolute value maximum drawdown obtained during the lifetime of the contract may be utilized. For example, a forward or futures contract on the average of the absolute value maximum drawdown having a payoff of

$$\frac{1}{T} {\int }_{0}^{T} {D}_{t} ⅆ t - K ,$$

a call option on the average of the absolute value maximum drawdown having a payoff of

$${( \frac{1}{T} {\int }_{0}^{T} {D}_{t} ⅆ t - K )}^{+} ,$$

or a put option on the average of the absolute value maximum drawdown having a payoff of

$${( K - \frac{1}{T} {\int }_{0}^{T} {D}_{t} ⅆ t )}^{+}$$

may be sold to an investor.

As described above in reference to the absolute value maximum drawdown crash option, the price, v(t,Sₜ,Mₜ,Dₜ), of financial contracts based on the absolute value maximum drawdown or the average of the absolute value maximum drawdown can be determined by taking the conditional expectation of the discounted payoff under the risk neutral measure:
v(t,Sₜ,Mₜ,Dₜ)=E[e^{-(T-t)}f({Dᵤ}ᵤ₌₀^{T})|Sₜ,Mₜ,Dₜ], [78]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the absolute value maximum drawdown or the average of the absolute value maximum drawdown has been set, the financial contract can be sold to an investor, and the predetermined payoff amount can be paid to the investor if certain conditions specified in the financial contract are met during the lifetime of the contract.

In some embodiments, rather than entering into financial contracts using the absolute value maximum drawdown, an investor may alternatively choose to invest in an actively traded portfolio with the intention to replicate or mimic the payoff of the financial contracts using the absolute value maximum drawdown. In this case, a financial institution can set up a portfolio using the hedge of the financial contracts using the absolute value maximum drawdown. The hedge of the financial contracts using the absolute value maximum drawdown can be given by vₛ(t,Sₜ,Mₜ,Dₜ) the standard delta hedge, which is the first derivative with respect to the price of the financial contracts using the absolute value maximum drawdown shown above. The final value of this portfolio can be the same or similar to the payoff of the financial contracts using the absolute value maximum drawdown.

In some embodiments, the price of financial contracts using the absolute value maximum drawdown or the average of the absolute value maximum drawdown may be used as a measure of risk or as an index of an asset. For example, as outlined above, the price of the absolute value maximum drawdown crash option may be used as a crash index.

Embodiments Based on Relative Value Maximum Drawdown

Any financial contract that depends on the process {Rₜ}ₜ₌₀^{T} may be viewed as a contingent claim depending on the relative value maximum drawdown Rₜ. Examples of such financial contracts include a forward or futures contract having a payoff of R_{T}−K, a call option having a payoff of (R_{T}−K)⁺, and a put option having a payoff of (K−R_{T})⁺, where K is the strike price of the asset.

Alternatively, the average of the relative value maximum drawdown obtained during the lifetime of the contract may be utilized. For example, a forward or futures contract on the average of the relative value maximum drawdown having a payoff of

$$\frac{1}{T} {\int }_{0}^{T} {R}_{t} ⅆ t - K ,$$

a call option on the average of the relative value maximum drawdown having a payoff of

$${( \frac{1}{T} {\int }_{0}^{T} {R}_{t} ⅆ t - K )}^{+} ,$$

or a put option on the average of the relative value maximum drawdown having a payoff of

$${( K - \frac{1}{T} {\int }_{0}^{T} {R}_{t} ⅆ t )}^{+}$$

may be sold to an investor.

As described above in reference to the relative value maximum drawdown crash option, the price, v(t,Sₜ,Mₜ,Rₜ), of financial contracts based on the relative value maximum drawdown or the average of the relative value maximum drawdown can be determined by taking the conditional expectation of the discounted payoff under the risk neutral measure:
v(t,Sₜ,Mₜ,Rₜ)=E[e^{-(T-t)}f({Rᵤ}ᵤ₌₀^{T})|Sₜ,Mₜ,Rₜ], [79]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the relative value maximum drawdown or the average of the relative value maximum drawdown has been set, the financial contract can be sold to an investor, and the predetermined payoff amount can be paid to the investor if certain conditions specified in the financial contract are met during the lifetime of the contract.

In some embodiments, rather than entering into financial contracts using the relative value maximum drawdown, an investor may alternatively choose to invest in an actively traded portfolio with the intention to replicate or mimic the payoff of the financial contracts using the relative value maximum drawdown. In this case, a financial institution can set up a portfolio using the hedge of the financial contracts using the relative value maximum drawdown. The hedge of the financial contracts using the relative value maximum drawdown can be given by vₛ(t,Sₜ,Mₜ,Rₜ), the standard delta hedge, which is the first derivative with respect to the price of the financial contracts using the relative value maximum drawdown shown above. The final value of this portfolio can be the same or similar to the payoff of the financial contracts using the relative value maximum drawdown.

In some embodiments, the price of the financial contracts using the relative value maximum drawdown or the average of the relative value maximum drawdown may be used as a measure of risk or as an index of an asset. For example, the price of the relative value maximum drawdown crash option may be used as a crash index.

Embodiments Based on Absolute Value Average Drawdown

Any financial contract that depends on the process {ADₜ}ₜ₌₀^{T} may be viewed as a contingent claim depending on the absolute value average drawdown ADₜ. Examples of such financial contracts include a forward or futures contract having a payoff of AD_{T}−K, a call option having a payoff of (AD_{T}−K)⁺, and a put option having a payoff of (K−AD_{T})⁺, where K is the strike price of the asset.

As described above in reference to the absolute value average drawdown crash option, the price, v(t,Sₜ,Mₜ,ADₜ), of financial contracts based on the absolute value average drawdown can be determined by taking the conditional expectation of the discounted payoff under the risk neutral measure:
v(t,Sₜ,Mₜ,ADₜ)=E[e^{-(T-t)}f({ADᵤ}ᵤ₌₀^{T})|Sₜ,Mₜ,ADₜ], [80]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the absolute value average drawdown has been set, the financial contract can be sold to an investor, and the predetermined payoff amount can be paid to the investor if certain conditions specified in the financial contract are met during the lifetime of the contract.

In some embodiments, rather than entering into financial contracts using the absolute value average drawdown, an investor may alternatively choose to invest in an actively traded portfolio with the intention to replicate or mimic the payoff of the financial contracts using the absolute value average drawdown. In this case, a financial institution can set up a portfolio using the hedge of the financial contracts using the absolute value average drawdown. The hedge of the financial contracts using the absolute value average drawdown can be given by vₛ(t,Sₜ,Mₜ,ADₜ), the standard delta hedge, which is the first derivative with respect to the price of the financial contracts using the absolute value average drawdown shown above. The final value of this portfolio can be the same or similar to the payoff of the financial contracts using the absolute value average drawdown.

In some embodiments, the price of financial contracts using the absolute value average drawdown may be used as a measure of risk or as an index of an asset. For example, the price of the absolute value average drawdown crash option may be used as a crash index.

Embodiments Based on Relative Value Average Drawdown

Any financial contract that depends on the process {ARₜ}ₜ₌₀^{T} may be viewed as a contingent claim depending on the relative value average drawdown ARₜ. Examples of such financial contracts include a forward or futures contract having a payoff of AR_{T}−K, a call option having a payoff of (AR_{T}−K)⁺, and a put option having a payoff of (K−AR_{T})⁺, where K is the strike price of the asset.

As described above in reference to the relative value average drawdown crash option, the price, v(t,Sₜ,Mₜ,ARₜ), of financial contracts based on the relative value average drawdown can be determined by taking the conditional expectation of the discounted payoff under the risk neutral measure:
v(t,Sₜ,Mₜ,ARₜ)=E[e^{-(T-t)}f({ARᵤ}ᵤ₌₀^{T})|Sₜ,Mₜ,ARₜ], [81]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the relative value average drawdown has been set, the financial contract can be sold to an investor, and the predetermined payoff amount can be paid to the investor if certain conditions specified in the financial contract are met during the lifetime of the contract.

In some embodiments, rather than entering into financial contracts using the relative value average drawdown, an investor may alternatively choose to invest in an actively traded portfolio with the intention to replicate or mimic the payoff of the financial contracts using the relative value average drawdown. In this case, a financial institution can set up a portfolio using the hedge of the financial contracts using the relative value average drawdown. The hedge of the financial contracts using the relative value average drawdown can be given by vₛ(t,Sₜ,Mₜ,ARₜ), the standard delta hedge, which is the first derivative with respect to the price of the financial contracts using the relative value average drawdown shown above. The final value of this portfolio can be the same or similar to the payoff of the financial contracts using the relative value average drawdown.

In some embodiments, the price of the financial contracts using the relative value average drawdown may be used as a measure of risk or as an index of an asset. For example, the price of the relative value average drawdown crash option may be used as a crash index.

Embodiments Based on Absolute Value Maximum Drawup

Any financial contract that depends on the process {dₜ}ₜ₌₀^{T} may be viewed as a contingent claim depending on the absolute value maximum drawup dₜ. Examples of such financial contracts include a forward or futures contract having a payoff of d_{T}−K, a call option having a payoff of (d_{T}−K)⁺, and a put option having a payoff of (K−d_{T})⁺, where K is the strike price of the asset.

Alternatively, the average of the absolute value maximum drawup obtained during the lifetime of the contract may be utilized. For example, a forward or futures contract on the average of the absolute value maximum drawup having a payoff of

$$\frac{1}{T} {\int }_{0}^{T} {d}_{t} ⅆ t - K ,$$

a call option on the average of the absolute value maximum drawup having a payoff of

$${( \frac{1}{T} {\int }_{0}^{T} {d}_{t} ⅆ t - K )}^{+} ,$$

or a put option on the average of the absolute value maximum drawup having a payoff of

$${( K - \frac{1}{T} {\int }_{0}^{T} {d}_{t} ⅆ t )}^{+}$$

may be sold to an investor.

As described above in reference to the absolute value maximum drawup rally option, the price, v(t,Sₜ,mₜ,dₜ), of financial contracts based on absolute value maximum drawup or average of the absolute value maximum drawup can be determined by taking the conditional expectation of the discounted payoff under the risk neutral measure:
v(t,Sₜ,mₜ,dₜ)=E[e^{-(T-t)}f({dᵤ}ᵤ₌₀^{T})|Sₜ,mₜdₜ], [82]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the absolute value maximum drawup or the average of the absolute value maximum drawup has been set, the financial contract can be sold to an investor, and the predetermined payoff amount can be paid to the investor if certain conditions specified in the financial contract are met during the lifetime of the contract.

In some embodiments, rather than entering into financial contracts using the absolute value maximum drawup, an investor may alternatively choose to invest in an actively traded portfolio with the intention to replicate or mimic the payoff of the financial contracts using the absolute value maximum drawup. In this case, a financial institution can set up a portfolio using the hedge of the financial contracts using the absolute value maximum drawup. The hedge of the financial contracts using the absolute value maximum drawup can be given by vₛ(t,Sₜ,mₜ,dₜ), the standard delta hedge, which is the first derivative with respect to the price of the financial contracts using the absolute value maximum drawup shown above. The final value of this portfolio can be the same or similar to the payoff of the financial contracts using the absolute value maximum drawup.

In some embodiments, the price of financial contracts using the absolute value maximum drawup or the average of the absolute value maximum drawup may be used as a measure of risk or as an index of an asset. For example, the price of the absolute value maximum drawup rally option may be used as a rally index.

Embodiments Based on Relative Value Maximum Drawup

Any financial contract that depends on the process {rₜ}ₜ₌₀^{T} may be viewed as a contingent claim depending on the relative value maximum drawup rₜ. Examples of such financial contracts include a forward or futures contract having a payoff of r_{T}−K, a call option having a payoff of (r_{T}−K)⁺, and a put option having a payoff of (K−r_{T})⁺, where K is the strike price of the asset.

Alternatively, the average of the relative value maximum drawup obtained during the lifetime of the contract may be utilized. For example, a forward or futures contract on the average of the relative value maximum drawup having a payoff of

$$\frac{1}{T} {\int }_{0}^{T} {r}_{t} ⅆ t - K ,$$

a call option on the average of the relative value maximum drawup having a payoff of

$${( \frac{1}{T} {\int }_{0}^{T} {r}_{t} ⅆ t - K )}^{+} ,$$

or a put option on the average of the relative value maximum drawup having a payoff of

$${( K - \frac{1}{T} {\int }_{0}^{T} {r}_{t} ⅆ t )}^{+}$$

may also be sold to an investor.

As described above in reference to the relative value maximum drawup rally option, the price, v(t,Sₜ,mₜ,rₜ), of financial contracts based on the relative value maximum drawup or average of the relative value maximum drawup can be determined by taking the conditional expectation of the discounted payoff under the risk neutral measure:
v(t,Sₜ,mₜ,rₜ)=E[e^{-(T-t)}f({rᵤ}ᵤ₌₀^{T})|Sₜ,mₜ,rₜ,] [83]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the relative value maximum drawup or the average of the relative value maximum drawup has been set, the financial contract can be sold to an investor, and the predetermined payoff amount can be paid to the investor if certain conditions specified in the financial contract are met during the lifetime of the contract.

In some embodiments, rather than contractually entering into financial contracts using the relative value maximum drawup, an investor may alternatively choose to invest in an actively traded portfolio with the intention to replicate or mimic the payoff of the financial contracts using the relative value maximum drawup. In this case, a financial institution may set up a portfolio using the hedge of the financial contracts using the relative value maximum drawup. The hedge of the financial contracts using the relative value maximum drawup may be given by vₛ(t,Sₜ,mₜ,rₜ), the standard delta hedge, which is the first derivative with respect to the price of the financial contracts using the relative value maximum drawup shown above. The final value of this portfolio may be the same or similar to the payoff of the financial contracts using the relative value maximum drawup.

In some embodiments, the price of the financial contracts using the relative value maximum drawup or the average of the relative value maximum drawup may be used as a measure of risk or as an index of an asset. For example, the price of the relative value maximum drawup rally option may be used as a rally index.

Embodiments Based on Absolute Value Average Drawup

Any financial contract that depends on the process {adₜ}ₜ₌₀^{T}, may be viewed as a contingent claim depending on the absolute value average drawup adₜ. Examples of such financial contracts include a forward or futures contract having a payoff of ad_{T}−K, a call option having a payoff of (ad_{T}−K)⁺, and a put option having a payoff of (K−ad_{T})⁺, where K is the strike price of the asset.

As described above in reference to the absolute value average drawup rally option, the price, v(t,Sₜ,mₜ,adₜ), of financial contracts based on absolute value average drawup can be determined by taking the conditional expectation of the discounted payoff under the risk neutral measure:
v(t,Sₜ,mₜ,adₜ)=E[e^{-(T-t)}f({adᵤ}ᵤ₌₀^{T})|Sₜ,mₜ,adₜ], [84]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the absolute value average drawup has been set, the financial contract can be sold to an investor, and the predetermined payoff amount can be paid to the investor if certain conditions specified in the financial contract are met during the lifetime of the contract.

In some embodiments, rather than entering into financial contracts using the absolute value average drawup, an investor may alternatively choose to invest in an actively traded portfolio with the intention to replicate or mimic the payoff of the financial contracts using the absolute value average drawup. In this case, a financial institution can set up a portfolio using the hedge of the financial contracts using the absolute value average drawup. The hedge of the financial contracts using the absolute value average drawup can be given by vₜ(t,Sₜ,mₜ,adₜ), the standard delta hedge, which is the first derivative with respect to the price of the financial contracts using the absolute value average drawup shown above. The final value of this portfolio can be the same or similar to the payoff of the financial contracts using the absolute value average drawup.

In some embodiments, the price of financial contracts using the absolute value average drawup may be used as a measure of risk or as an index of an asset. For example, the price of the absolute value average drawup rally option may be used as a rally index.

Embodiments Based on Relative Value Average Drawup

Any financial contract that depends on the process {arₜ}ₜ₌₀^{T} may be viewed as a contingent claim depending on the relative value average drawup arₜ. Examples of such financial contracts include a forward or futures contract having a payoff of ar_{T}−K, a call option having a payoff of (ar_{T}−K)⁺, and a put option having a payoff of (K−ar_{T})⁺, where K is the strike price of the asset.

As described above in reference to the relative value average drawup rally option, the price, v(t,Sₜ,mₜ,arₜ), of financial contracts based on the relative value average drawup can be determined by taking the conditional expectation of the discounted payoff under the risk neutral measure:
v(t,Sₜ,mₜ,arₜ)=E[e^{-(T-t)}f({arᵤ}ᵤ₌₀^{T})|Sₜ,mₜ,arₜ], [85]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the relative value average drawup has been set, the financial contract can be sold to an investor, and the predetermined payoff amount can be paid to the investor if certain conditions specified in the financial contract are met during the lifetime of the contract.

In some embodiments, rather than contractually entering into financial contracts using the relative value average drawup, an investor may alternatively choose to invest in an actively traded portfolio with the intention to replicate or mimic the payoff of the financial contracts using the relative value average drawup. In this case, a financial institution may set up a portfolio using the hedge of the financial contracts using the relative value average drawup. The hedge of the financial contracts using the relative value average drawup may be given by vₛ(t,Sₜ,mₜ,arₜ), the standard delta hedge, which is the first derivative with respect to the price of the financial contracts using the relative value average drawup shown above. The final value of this portfolio may be the same or similar to the payoff of the financial contracts using the relative value average drawup.

In some embodiments, the price of the financial contracts using the relative value average drawup may be used as a measure of risk or as an index of an asset. For example, the price of the relative value average drawup rally option may be used as a rally index.

Embodiments Based on Absolute Value Maximum Range

Any financial contract that depends on the process {RNGₜ}ₜ₌₀^{T} may be viewed as a contingent claim depending on the absolute value maximum range RNGₜ. Examples of such financial contracts include a forward or futures contract having a payoff of RNG_{T}−K, a call option having a payoff of (RNG_{T}−K)⁺, and a put option having a payoff of (K−RNG_{T})⁺, where K is the strike price of the asset.

Alternatively, the average of the absolute value maximum range obtained during the lifetime of the contract may be utilized. For example, a forward or futures contract on the average of the absolute value maximum range having a payoff of

$$\frac{1}{T} {\int }_{0}^{T} {RNG}_{t} ⅆ t - K ,$$

a call option on the average of the absolute value maximum range having a payoff of

$${( \frac{1}{T} {\int }_{0}^{T} {RNG}_{t} ⅆ t - K )}^{+} ,$$

or a put option on the average of the absolute value maximum range having a payoff of

$${( K - \frac{1}{T} {\int }_{0}^{T} {RNG}_{t} ⅆ t )}^{+}$$

may be sold to an investor.

As described above in reference to the absolute value maximum range option, the price, v(t,Sₜ,Mₜ,mₜ,RNGₜ), of financial contracts based on absolute value maximum range or average of the absolute value maximum range can be determined by taking the conditional expectation of the discounted payoff under the risk neutral measure:
v(t,Sₜ,Mₜ,mₜ,RNGₜ)=E[e^{-(T-t)}f({RNGᵤ}ᵤ₌₀^{T})|Sₜ,Mₜ,mₜ,RNGₜ], [86]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

The hedge of the financial contracts may be given by the standard delta hedge vₛ(t,Sₜ,Mₜ,mₜ,RNGₜ), the first derivative with respect to the asset price Sₜ.

Once the price of a financial contract using the absolute value maximum range or the average of the absolute value maximum range has been set, the financial contract can be sold to an investor, and the predetermined payoff amount can be paid to the investor if certain conditions specified in the financial contract are met during the lifetime of the contract.

In some embodiments, rather than entering into financial contracts using the absolute value maximum range, an investor may alternatively choose to invest in an actively traded portfolio with the intention to replicate or mimic the payoff of the financial contracts using the absolute value maximum range. In this case, a financial institution can set up a portfolio using the hedge of the financial contracts using the absolute value maximum range. The hedge of the financial contracts using the absolute value maximum range can be given by vₛ(t,Sₜ,Mₜ,mₜ,RNGₜ), the standard delta hedge, which is the first derivative with respect to the price of the financial contracts using the absolute value maximum range shown above. The final value of this portfolio can be the same or similar to the payoff of the financial contracts using the absolute value maximum range.

In some embodiments, the price of financial contracts using the absolute value maximum range or the average of the absolute value maximum range may be used as a measure of risk or as an index of an asset. For example, the price of the absolute value maximum range option may be used as a range index.

Embodiments Based on Relative Value Maximum Range

Any financial contract that depends on the process {rngₜ}ₜ₌₀^{T} may be viewed as a contingent claim depending on the relative value maximum range rngₜ. Examples of such financial contracts include a forward or futures contract having a payoff of rng_{T}−K, a call option having a payoff of (rng_{T}−K)⁺, and a put option having a payoff of (K−rng_{T})⁺, where K is the strike price of the asset.

Alternatively, the average of the relative value maximum range obtained during the lifetime of the contract may be utilized. For example, a forward or futures contract on the average of the relative value maximum range having a payoff of

$$\frac{1}{T} {\int }_{0}^{T} {rng}_{t} ⅆ t - K ,$$

a call option on the average of the relative value maximum range having a payoff of

$${( \frac{1}{T} {\int }_{0}^{T} {rng}_{t} ⅆ t - K )}^{+} ,$$

or a put option on the average of the relative value maximum range having a payoff of

$${( K - \frac{1}{T} {\int }_{0}^{T} {rng}_{t} ⅆ t )}^{+}$$

may be sold to an investor.

As described above in reference to the relative value maximum range option, the price, v(t,Sₜ,Mₜ,mₜ,rngₜ), of financial contracts based on the relative value maximum range or average of the relative value maximum range can be determined by taking the conditional expectation of the discounted payoff under the risk neutral measure:
v(t,Sₜ,Mₜ,mₜ,rngₜ)=E[e^{-(T-t)}f({rngᵤ}ᵤ₌₀^{T})|Sₜ,Mₜ,mₜ,rngₜ], [87]
where f is the payoff function. This expectation may be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the relative value maximum range or the average of the relative value maximum range has been set, the financial contract can be sold to an investor, and the predetermined payoff amount can be paid to the investor if certain conditions specified in the financial contract are met during the lifetime of the contract.

In some embodiments, rather than contractually entering into financial contracts using the relative value maximum range, an investor may alternatively choose to invest in an actively traded portfolio with the intention to replicate or mimic the payoff of the financial contracts using the relative value maximum range. In this case, a financial institution can set up a portfolio using the hedge of the financial contracts using the relative value maximum range. The hedge of the financial contracts using the relative value maximum range can be given by vₛ(t,Sₜ,Mₜ,mₜ,rngₜ), the standard delta hedge, which is the first derivative with respect to the price of the financial contracts using the relative value maximum range shown above. The final value of this portfolio can be the same or similar to the payoff of the financial contracts using the relative value maximum range.

In some embodiments, the price of financial contracts using the relative value maximum range or the average of the relative value maximum range may be used as a measure of risk or as an index of an asset. For example, the price of the relative value maximum range option may be used as a range index.

Embodiments Based on Absolute Value Average Range

Any financial contract that depends on the process {ARNGₜ}ₜ₌₀^{T} may be viewed as a contingent claim depending on the absolute value average range ARNGₜ. Examples of such financial contracts include a forward or futures contract having a payoff of ARNG_{T}−K, a call option having a payoff of (ARNG_{T}−K)⁺, and a put option having a payoff of (K−ARNG_{T})⁺, where K is the strike price of the asset.

As described above in reference to the absolute value average range option, the price, v(t,Sₜ,Mₜ,mₜ,ARNGₜ), of financial contracts based on absolute value average range can be determined by taking the conditional expectation of the discounted payoff under the risk neutral measure:
v(t,Sₜ,Mₜ,mₜ,ARNGₜ)=E[e^{-(T-t)}f({ARNGᵤ}ᵤ₌₀^{T})|Sₜ,Mₜ,mₜ, ARNGₜ], [88]
where f is the payoff function. This expectation can be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

The hedge of the financial contracts may be given by the standard delta hedge vₛ(t,Sₜ,Mₜ,mₜ,ARNGₜ), the first derivative with respect to the asset price Sₜ.

Once the price of a financial contract using the absolute value average range has been set, the financial contract can be sold to an investor, and the predetermined payoff amount can be paid to the investor if certain conditions specified in the financial contract are met during the lifetime of the contract.

In some embodiments, rather than entering into financial contracts using the absolute value average range, an investor may alternatively choose to invest in an actively traded portfolio with the intention to replicate or mimic the payoff of the financial contracts using the absolute value average range. In this case, a financial institution can set up a portfolio using the hedge of the financial contracts using the absolute value average range. The hedge of the financial contracts using the absolute value average range can be given by vₛ(t,Sₜ,Mₜ,mₜ,ARNGₜ), the standard delta hedge, which is the first derivative with respect to the price of the financial contracts using the absolute value average range shown above. The final value of this portfolio can be the same or similar to the payoff of the financial contracts using the absolute value average range.

In some embodiments, the price of financial contracts using the absolute value average range may be used as a measure of risk or as an index of an asset. For example, the price of the absolute value average range option may be used as a range index.

Embodiments Based on Relative Value Average Range

Any financial contract that depends on the process {arngₜ}ₜ₌₀^{T} may be viewed as a contingent claim depending on the relative value average range arngₜ. Examples of such financial contracts include a forward or futures contract having a payoff of arng_{T}−K, a call option having a payoff of (arng_{T}−K)⁺, and a put option having a payoff of (K−arng_{T})⁺, where K is the strike price of the asset.

As described above in reference to the relative value average range option, the price, v(t,Sₜ,Mₜ,mₜ,arngₜ), of financial contracts based on the relative value average range can be determined by taking the conditional expectation of the discounted payoff under the risk neutral measure:
v(t,Sₜ,Mₜ,mₜ,arngₜ)=E[e^{-(T-t)}f({arngᵤ}ᵤ₌₀^{T})|Sₜ,Mₜ,mₜ,arngₜ] [89]
where f is the payoff function. This expectation may be computed by using standard Monte Carlo simulations. The pricing via conditional expectations can be linked to partial differential equations through Feynman-Kac theorem, as can be found, for example, in Shreve, S., “Stochastic Calculus for Finance II,” Springer-Verlag, 2004, and solved numerically.

Once the price of a financial contract using the relative value average range has been set, the financial contract can be sold to an investor, and the predetermined payoff amount can be paid to the investor if certain conditions specified in the financial contract are met during the lifetime of the contract.

In some embodiments, rather than contractually entering into financial contracts using the relative value average range, an investor may alternatively choose to invest in an actively traded portfolio with the intention to replicate or mimic the payoff of the financial contracts using the relative value average range. In this case, a financial institution can set up a portfolio using the hedge of the financial contracts using the relative value average range. The hedge of the financial contracts using the relative value average range can be given by vₛ(t,Sₜ,Mₜ,mₜ,arngₜ), the standard delta hedge, which is the first derivative with respect to the price of the financial contracts using the relative value average range shown above. The final value of this portfolio can be the same or similar to the payoff of the financial contracts using the relative value average range.

In some embodiments, the price of financial contracts using the relative value average range may be used as a measure of risk or as an index of an asset. For example, the price of the relative value average range option may be used as a range index.

System

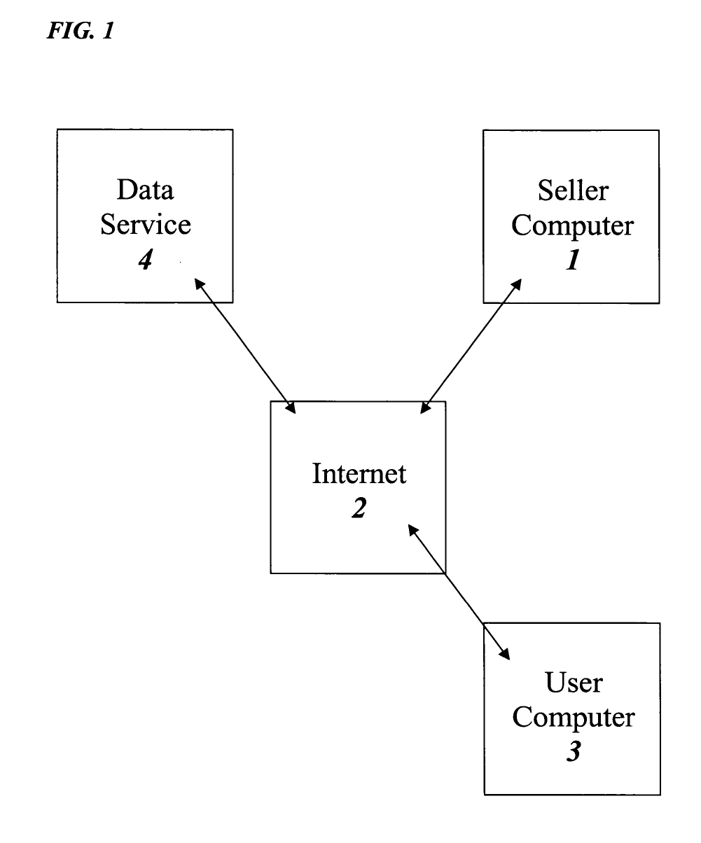

Certain embodiments of the invention are directed to products or systems for providing carrying out the methods described above. Such a product is described with reference to FIG. 1 for clarity.

A seller, (e.g., an insurer, a hedge fund manager, an investment banker, a financial institution, and the like), can determine the event of, for example, a market crash, a market rally, or a range event as previously described. The seller can determine the payoff amount and the price of each financial contract described above. Moreover, if a trading account is to be sold, the seller can determine the hedge of each financial contracts described above. Suitable computer software provided in Seller Computer 1 may serve these requisite functions. For example, the underlying asset of the options may be a particular stock price, an index such as the Dow Jones, Standards and Poor 500, NASDAQ, or a market crash index, or a market rally index, as previously described. Additionally, the price of the financial contracts may include a cost associated with using the market crash index information or the market rally index information.

The seller can advertise the various different financial contracts or trading accounts available for purchase by an investor through a communications network such as, for example, Internet 2. An investor can, through a suitable software product, such as an Internet web browser installed in User Computer 3, request the purchase of one or more desired financial contracts or trading accounts from Seller Computer 1. Based on the investor's request, the seller can sell the desired one or more financial contracts or trading accounts to the investor.

Once the sale of the financial contracts or trading accounts has been completed, one or both of Seller Computer 1 and User Computer 3 can monitor a Data Service 4 (for example, a particular stock price from insurer database, the Dow Jones index, the NASDAQ index, etc.) through Internet 2 to observe and calculate whether a market crash, a market rally, a range event, a maximum drawdown, a maximum drawup, and/or the like has occurred.

If a market crash, a market rally, a range event, a maximum drawdown, a maximum drawup, or the like is not observed during the lifetime of the contract, the one or more financial contracts or trading accounts the investor purchased can expire as worthless. However, if a market crash, a market rally, a range event, a maximum drawdown, a maximum drawup, or the like is observed, software installed in one or both of Seller Computer 1 and User Computer 3 can alert the seller and the investor that a payoff may be required for the purchased financial contract(s) or trading account(s). The seller then pays the investor the necessary payoff amount, and the one or more purchased financial contracts or trading accounts can expire. In one example, this payoff can be automatically performed by Seller Computer 1 to User Computer 3 via a suitable investment or banking account.

### EXAMPLES

The following examples will further illustrate certain embodiments of the present invention. Value of an asset (e.g., a stock price) may fluctuate as shown in Table 1. The financial contract may agree to treat all negative values of market indicators as having zero value as shown below:

TABLE 1
Table depicting the various market indicators of the present invention

| | Day 1 | Day 2 | Day 3 | Day 4 | Day 5 | Day 6 |
|---|---|---|---|---|---|---|
| Daily stock | $10 | $7 | $3 | $8 | $6 | $1 |
| price | | | | | | |
| Absolute | | $3 | $7 | $2 | $4 | $9 |
| value | | | | | | |
| drawdown | | | | | | |
| Absolute | | $3 | $7 | $7 | $7 | $9 |
| value | | | | | | |
| maximum | | | | | | |
| drawdown | | | | | | |
| Absolute | | $0 | $0 | $5 | $3 | $0 |
| value | | | | | | |
| drawup | | | | | | |
| Absolute | | $0 | $0 | $5 | $5 | $5 |
| value | | | | | | |
| maximum | | | | | | |
| drawup | | | | | | |
| Absolute | | $3 | $7 | $7 | $7 | $9 |
| value | | | | | | |
| maximum | | | | | | |
| range | | | | | | |

As shown in Table 1, the absolute value drawdown may calculate the drawdown values between the maximum stock price and the stock price of each consecutive days whereas the absolute value maximum drawdown maintains a running record of the maximum drawdown that occurred during the lifetime of the contract. Hence, the average absolute value drawdown is

$$\frac{\$3 + \$7 + \$2 + \$4 + \$9}{5} = \$5 ,$$

and the average of the absolute value maximum drawdown is

$$\frac{\$3 + \$7 + \$7 + \$7 + \$9}{5} = \$6 .6 .$$

Similarly, the absolute value drawup may calculate the drawup values between the minimum stock price and the stock price of each consecutive days whereas the absolute value maximum drawup maintains a running record of the maximum drawup that occurred during the lifetime of the contract. Hence, the average absolute value drawup is

$$\frac{\$0 + \$0 + \$5 + \$3 + \$0}{5} = \$1 .6 ,$$

and the average of the absolute value maximum drawup is

$$\frac{\$0 + \$0 + \$5 + \$5 + \$5}{5} = \$3 .$$

The absolute value maximum range may calculate the range values between the maximum stock price during the lifetime of the contract compared with the minimum stock price during the lifetime of the contract. Hence, the average absolute value maximum range is

$$\frac{\$3 + \$7 + \$7 + \$7 + \$9}{5} = \$6 .6 .$$

As described above, any financial contracts, trading accounts, or indices may be defined utilizing any one of the market indicators described above. For example, if a financial contract to insure against the event of a market crash is desired, the absolute value maximum drawdown may be utilized which agrees that if the absolute value maximum drawdown exceeds $4, an investor may receive a payoff amount equal to $4. Hence, on day 6, where the absolute value maximum drawdown exceeds $4 (i.e., the value is $5), the investor may receive a payoff amount of $4.

Upon review of the present description and embodiments, those skilled in the art will understand that modifications and equivalent substitutions may be performed in carrying out the invention without departing from the scope and spirit of the invention. Thus, the invention is not meant to be limiting by the embodiments described explicitly above.

What is claimed is:

1. A method for providing an investor with one or more financial contracts, the method comprising:
(a) defining an average drawdown value, an average drawup value, and/or an average range value;
(b) defining one or more financial contracts based on the average drawdown value, the average drawup value, and/or the average range value, wherein
the one or more financial contracts comprises one or more conditions, and
the one or more financial contracts specify a payoff amount to be paid to the investor if the one or more conditions specified in the one or more financial contracts are met during a lifetime of the one or more financial contracts;
(c) pricing the financial contract; and
(d) transferring the one or more financial contracts to the investor.

2. The method of claim 1, wherein the one or more financial contracts is selected from the group consisting of:
a forward contract;
a futures contract;
a call options contract;
a put options contract;
a crash options contract; and
combinations thereof.

3. The method of claim 1, wherein the average drawdown value is
an average absolute drop of an asset value with respect to a running maximum of the asset value during the lifetime of the financial contract; or
an average relative drop of the asset value with respect to the running maximum of the asset value during the lifetime of the financial contract.

4. The method of claim 3, wherein the one or more financial contracts is selected from the group consisting of:
a forward contract;
a futures contract;
a call options contract;
a put options contract;
a crash options contract; and
combinations thereof.

5. The method of claim 1, wherein the average drawup value is
an average absolute increase of an asset value with respect to a running minimum of the asset value during the lifetime of the financial contract; or
an average relative increase of the asset value with respect to the running minimum of the asset value during the lifetime of the financial contract.

6. The method of claim 5, wherein the one or more financial contracts is selected from the group consisting of:
a forward contract;
a futures contract;
a call options contract;
a put options contract;
a crash options contract; and
combinations thereof.

7. The method of claim 1, wherein the average range value is
an average absolute difference between a running minimum asset value and a running maximum asset value during the lifetime of the financial contract; or
an average relative difference between the running minimum asset value and the running maximum asset value during the lifetime of the financial contract.

8. The method of claim 7, wherein the one or more financial contracts is selected from the group consisting of:
a forward contract;
a futures contract;
a call options contract;
a put options contract;
a crash options contract; and
combinations thereof.

9. A method for providing an investor with one or more trading accounts, the method comprising:
(a) defining an average drawdown value, an average drawup value, and/or an average range value;
(b) defining one or more financial contracts based on the average drawdown value, the average drawup value, and/or the average range value, wherein
the one or more financial contracts comprises one or more conditions, and
the one or more financial contracts specify a payoff amount to be paid to the investor if one or more conditions specified in the one or more financial contracts are met during a lifetime of the one or more financial contracts;
(c) pricing the one or more financial contracts;
(d) determining a hedge of the one or more financial contracts based on the price of the one or more financial contracts;
(e) defining a payoff of the one or more trading accounts based on the payoff amount of the one or more financial contracts; and
(f) transferring the one or more trading accounts to the investor.

10. The method of claim 9, wherein the one or more financial contracts is selected from the group consisting of:
a forward contract;
a futures contract;
a call options contract;
a put options contract;
a crash options contract; and
combinations thereof.

11. The method of claim 9, wherein the average drawdown value is
an average absolute drop of an asset value with respect to a running maximum of the asset value during the lifetime of the financial contract; or
an average relative drop of the asset value with respect to the running maximum of the asset value during the lifetime of the financial contract.

12. The method of claim 11, wherein the one or more financial contracts is selected from the group consisting of:
a forward contract;
a futures contract;
a call options contract;
a put options contract;
a crash options contract; and
combinations thereof.

13. The method of claim 9, wherein the average drawup value is
an average absolute increase of an asset value with respect to a running minimum of the asset value during the lifetime of the financial contract; or
an average relative increase of the asset value with respect to the running minimum of the asset value during the lifetime of the financial contract.

14. The method of claim 13, wherein the one or more financial contracts is selected from the group consisting of:
a forward contract;
a futures contract;
a call options contract;
a put options contract;
a crash options contract; and
combinations thereof.

15. The method of claim 9, wherein the average range value is
an average absolute difference between a running minimum asset value and a running maximum asset value during the lifetime of the financial contract; or
an average relative difference between the running minimum asset value and the running maximum asset value during the lifetime of the financial contract.

16. The method of claim 15, wherein the one or more financial contracts is selected from the group consisting of:
a forward contract;
a futures contract;
a call options contract;
a put options contract;
a crash options contract; and
combinations thereof.

17. An apparatus for providing an investor with one or more financial contracts, the apparatus comprising:
(a) means for defining an average drawdown value, an average drawup value, and/or an average range value;
(b) means for defining one or more financial contracts based on the average drawdown value, the average drawup value, and/or the average range value, wherein
the one or more financial contracts comprises one or more conditions, and
the one or more financial contracts specify a payoff amount to be paid to the investor if the one or more conditions specified in the one or more financial contracts are met during a lifetime of the one or more financial contracts;
(c) means for pricing the financial contract; and
(d) means for transferring the one or more financial contracts to the investor.

18. An apparatus for providing an investor with one or more trading accounts, the apparatus comprising:
(a) means for defining an average drawdown value, an average drawup value, and/or an average range value;
(b) means for defining one or more financial contracts based on the average drawdown value, the average drawup value, and/or the average range value, wherein
the one or more financial contracts comprises one or more conditions, and
the one or more financial contracts specify a payoff amount to be paid to the investor if one or more conditions specified in the one or more financial contracts are met during a lifetime of the one or more financial contracts;
(c) means for pricing the one or more financial contracts;
(d) means for determining a hedge of the one or more financial contracts based on the price of the one or more financial contracts;
(e) means for defining a payoff of the one or more trading accounts based on the payoff amount of the one or more financial contracts; and
(f) means for transferring the one or more trading accounts to the investor.
